(19) United States
(12) Patent Application Publication
(10) Pub. No.: US 2017/0112050 A1
(43) Pub. Date: Apr. 27, 2017

(54) COMPOSITIONS FOR SOIL CARBON SEQUESTRATION AND RESTORATION AND METHODS FOR MAKING AND USING THEM

(71) Applicants: Thomas Julius Borody, Five Dock (AU); Robert Vincin, Five Dock (AU)

(72) Inventors: Thomas Julius Borody, Five Dock (AU); Robert Vincin, Five Dock (AU)

(21) Appl. No.: 15/129,409

(22) PCT Filed: Mar. 27, 2015
(86) PCT No.: PCT/AU2015/000181

§ 371 Date: Sep. 26, 2016

Related U.S. Application Data
(60) Provisional application No. 61/971,428, filed on Mar. 27, 2014.

(51) Int. Cl. A01C 21/00; C05G 3/00; A01C 1/06; A01N 25/00

(52) U.S. Cl. CPC A01C 21/005; A01N 25/00; C05G 3/00; A01C 1/06

(57) ABSTRACT

In alternative embodiments, the invention provides compositions and methods for the restoration of soil carbon content by carbon sequestration, or storage of carbon in a stable and sustainable form, for example, in an exhausted soil. In alternative embodiments, use of compositions of the invention and practicing methods of the invention results in a net increase in Soil Organic Carbon (SOC). In alternative embodiments, the invention provides compositions comprising, or consisting of a combination or a mixture of seeds, wherein the mixture comprises seeds of at least one C4 photosynthesis pathway grass and at least one of any member of the genus A triplex, or in alternative embodiments, the combination or mixture comprises seeds of at least two C4 photosynthesis pathway grasses and at least one of any member of the genus Atriplex.

### TECHNICAL FIELD

This invention generally relates to soil science, pedology and microbiology. In alternative embodiments, the invention provides compositions and methods for the restoration of soil carbon content by carbon sequestration, or storage of carbon in a stable and sustainable form, for example, in an exhausted soil. In alternative embodiments, use of compositions of the invention and practicing methods of the invention results in a net increase in Soil Organic Carbon (SOC). In alternative embodiments, the invention provides compositions comprising, or consisting of, a mixture or a combination of seeds, wherein the combination or mixture comprises seeds of at least one C4 photosynthesis pathway grass and at least one of any member of the genus Atriplex, or alternatively, the combination or mixture comprises seeds of at least two C4 photosynthesis pathway grasses and at least one of any member of the genus Atriplex.

### BACKGROUND

Climate change and climate variability are long-term environmental issues facing all nations. In this context governments and scientists in various developmental organisations and in the private sector are increasingly recognizing that dry lands, grass lands and range lands deserve greater focus not only because they constitute a large area of the world but because there has been widespread degradation and desertification.

Soil represents the world's largest carbon sink and when combined with agricultural technology the activities to replant such lands with plants that sequester carbon will do much for climate change mitigation. Degradation of the land base negatively affects the accumulation of carbon in the soil. Hence arresting and reversing land degradation, especially in dry land areas, through improved planting of appropriate species would contribute to the restoring of soil carbon but also improving livestock based economies.

Carbon sinks can be developed in a number of ways. In recent years there has been a slowly increasing build-up of carbon dioxide in the air largely due to the activity of mankind both in the progressive destruction of plants and by producing CO₂ through industrial activity, which dates back to the commencement of the ‘Industrial Revolution’. Atmospheric CO₂ has increased from around 278 mol-1 in AD 1750 to the current ambient level of almost 393 parts per million (Maunaloa Observatory, Hawaii:NOAA-ESRL). Current projections are for CO₂ concentrations to continue rising to levels as high as 500-1000 ppm by the year 2100 (IPCC 2007).

The recognition of the build-up of CO₂ in the atmosphere has stimulated activity that may lead to methods of reducing carbon dioxide emissions and by increasing carbon sequestration processes. On a global basis atmospheric CO₂ concentration has been well measured and is not disputed, but the understanding of the sources and how carbon dioxide can be returned to the soil are uncertain and a challenge. Furthermore, there has been an understanding that there is a large missing sink of around 1.4×10/15 gCy per year (Schimel et al 1995). There are natural biological systems on land that can function as sources of carbon sinks, the major components of which is Soil Organic Carbon (SOC) storage. Some 2% to 6% of earth's vegetation is capable of sequestering significant amounts of CO₂ to become carbon soil. As the result of the need to find effective carbon sinks there is growing research activity to find the best combinations and compositions of plants and chemicals to increase carbon sequestration.

### SUMMARY

In alternative embodiments, the invention provides compositions comprising, or consisting of, a mixture or a combination of seeds, or a plurality of seeds, wherein the mixture or combination or plurality of seeds comprises seeds of at least one C4 photosynthesis pathway grass and at least one of any member of the genus Atriplex, wherein optionally the mixture or combination is about 50% C4 photosynthesis pathway grass and 50% genus Atriplex, or between about 1% to 99% C4 photosynthesis pathway grass to a corresponding 1% to 99% genus Atriplex, and optionally the mixture or combination comprises seeds of at least two different C4 photosynthesis pathway grasses and at least one of any member of the genus Atriplex.

In alternative embodiments, the invention provides products of manufacture comprising, or consisting of, a mixture or a combination of seeds, or a plurality of seeds, wherein the mixture or combination or plurality of seeds comprises seeds of at least one C4 photosynthesis pathway grass and at least one of any member of the genus Atriplex, wherein optionally the mixture is about 50% C4 photosynthesis pathway grass and 50% genus Atriplex, or between about 1% to 99% C4 photosynthesis pathway grass to a corresponding 1% to 99% genus Atriplex, and optionally the mixture or combination comprises seeds of at least two different C4 photosynthesis pathway grasses and at least one of any member of the genus Atriplex.

In alternative embodiments of the composition or the products of manufacture of the invention, the at least one of any member of the genus Atriplex is selected from the group consisting of,
Atriplex canescens (Pursh) Nutt. Chamiso, Chamiza, Four-winged Saltbush, Grey Sagebrush, in North America,
Atriplex centralasiatica Iljin, in Asia,
Atriplex cinerea Poir, Grey Saltbush, Truganini, in Australia,
Atriplex codonocarpa P. G. Wilson, in Australia,
Atriplex conduplicata F. Muell, in Australia,
Atriplex confertifolia (Torr. & Frem.) S. Watson, Shadscale (Saltbush), in North America,
Atriplex cordobensis Gand. & Stuck, in South America,
Atriplex deserticola Phil, in South America,
Atriplex dimorphostegia Kar. & Kir, in North Africa,
Atriplex eardleyae Aellen, in Australia,
Atriplex elachophvlla F. Muell, in Australia,
Atriplex fissivalvis F. Muell, in Australia,
Atriplex flabellum Bunge ex Boiss, in Eurasia,
Atriplex gardneri (Moq.) D. Dietr, Gardner's saltbush, Moundscale, in NorthAmerica,
Atriplex glauca L, in Portugal, Spain and in North Africa,
Atriplex halimus L, Mediterranean Saltbush, Sea Orache, Shrubby Orache, in South, Europe, North Africa and Southwest Asia,
Atriplex herzogii Standl, in North America,
Atriplex holocarpa F. Muell, in Australia,
Atriplex hymenelytra (Ton.) S. Watson, Desert Holly, in North America,
Atriplex hymenotheca Moq, in Australia,
Atriplex imbricata (Moq.) D. Dietr, in South America,
Atriplex inamoena Aellen, in Eurasia,
Atriplex intermedia Anderson, in Australia,
Atriplex isatidea Moq, in Australia,
Atriplex laciniata L., Frosted Orache, In West and North Europe,
Atriplex lampa (Moq.) Gillies ex Small, in South America,
Atriplex lehmanniana Bunge, in Eurasia,
Atriplex lentiformis (Ton.) S. Watson, Quail Bush, in North America,
Atriplex leptocarpa F. Muell, in Australia,
Atriplex leucoclada. Boiss, in Eurasia,
Atriplex leucophylla (Moq.) D. Dietr, in North America,
Atriplex lindleyi Moq, in Australia,
Atriplex moneta Bunge ex Boiss, in Eurasia,
Atriplex muelleri Benth, in Australia,
Atriplex nessorhina S. W. L. Jacobs, in Australia,
Atriplex obovata Moq, in North America,
Atriplex pamirica Iljin, in Eurasia,
Atriplex parishii S. Watson, in North America,
Atriplex parryi S. Watson, in North America,
Atriplex parvifolia Kunth, in South America,
Atriplex patagonica (Moq.) D. Dietr, in South America,
Atriplex phyllostegia (Torn ex S. Watson) S. Watson, in North America,
Atriplex polycarpa (Ton.) S. Watson—Allscale (Saltbush), Desert Saltbush, Cattle Saltbush, Cattle Spinach, in North America,
Atriplex powellii S. Watson—Powell's Saltbush, in North America,
Atriplex pseudocampanulata Aellen, in Australia
Atriplex quinii F. Muell, in Australia
Atriplex recurva d′Urv, in Eurasia, endemic to the Aegaeis
Atriplex rhagodioides F. Muell, in Australia
Atriplex rosea L.—Tumbling Orache, in Eurasia and North Africa
Atriplex rusbyi Britton ex Rusby, in South America
Atriplex schugnanica Iljin, in Asia
Atriplex semibaccata R. Br., Australian Saltbush, Berry Saltbush, Creeping Saltbush, in Australia,
Atriplex semilunaris Aellen, in Australia,
Atriplex serenana A. Nelson ex Abrams, in North America,
Atriplex sibirica L.; in Asia, naturalized in Europe,
Atriplex sphaeromorpha Iljin, in Russia, Ukraine and Caucasus,
Atriplex spinibractea Anderson, in Australia,
Atriplex spongiosa. F. Muell, in Australia,
Atriplex stipitata Benth, in Australia,
Atriplex sturtii S. W. L. Jacobs, in Australia,
Atriplex suberecta I. Verd.—sprawling saltbush, lagoon saltbush, in Australia,
Atriplex tatarica Aellen, in Europe, North Africa and Asia,
Atriplex turbinata (Anderson) Aellen, in Australia,
Atriplex undulata (Moq.) D. Dietr, in South America,
Atriplex velutinella F. Muell, in Australia,
Atriplex vesicaria Heward ex Benth.—Bladder Saltbush, in Australia, and
any mixture or combination thereof.

In alternative embodiments of the composition or the products of manufacture of the invention the at least one C4 pathway grass is selected from the group consisting of:

| | |
|---|---|
| Aristida | Wire Grass, |
| Astrebla | Mitchell grass, |
| Bothriochloa | Blue & Red-leg grass, |
| Brachiaria | Armgrass, |
| Brachyachne (ciliaris) | Hairy native couch, |
| Chloris | Windmill-grass, |
| Chrysopogon (fallax) | Golden-beard grass, |
| Cymbopogon | Lemon-scented grass & Silky-heads, |
| Cynodon (dactylon var. pulchellus) | Couch-grass, |
| Dactyloctenium (radulans) | Button grass, |
| Dichanthium | Blue-grass, |
| Digitaria | Spider grass, |
| Distichlis (distichophylla) | Emu or Salt-grass, |
| Echinochloa | Channel millet, |
| Enneapogon | Bottle-washers, |
| Enteropogon | Umbrella-grass & Curly windmill- |
| | grass, |
| Eragrostis | Lovegrass, |
| Eriachne | Wanderrie, |
| Eriochloa | Cupgrass, |
| Eulalia (aurea) | Sugar-grass, |
| Hemarthria (uncinata) | Mat grass, |
| Imperata (cylindrica) | Kunai grass, |
| Iseilema | Flinders-grass, |
| Leptochloa | Umbrella cane-grass & Beetle-grass, |
| Neurachne (munroi) | Window mulga-grass, |
| Oxychloris (scariosa) | Winged chloris, |
| Panicum | Panic & Native millet, |
| Paractaenum | Barbed-wire grass, |
| Paraneurachne (muelleri) | Northern mulga-grass, |
| Perotis (rara) | Comet grass, |
| Pseudoraphis (spinescens) | Spiny mud-grass, |
| Setaria | Pigeon-grass & Paspalidium, |
| Spinifex (hirsutus) | Rolling spinifex, |
| Sporobolus | Dropseed, |
| Themeda | Kangaroo grass, |
| Tragus (australianus) | Burr-grass, |
| Triodia | Spinifex & Porcupine grass, |
| Tripogon (loliiformis) | Five-minute grass, |
| Triraphis (mollis) | Purple heads, |
| Uranthoecium (truncatum) | Flat-stem grass, |
| Yakirra (australiensis) | Bunch panic, |
| Zoysia (macrantha) | Manila grass, |
| Zygochloa (paradoxa) | Sandhill cane-grass, |

any C4 grass member of the family Fabaceae or Leguminosae,
any member of the genus Pennisetum;
a Kikuyu grass, or Penniselum Clandestinum,
any member of the genus Trifolium, or any clover,
a Trifolium alexandrinum, and
any mixture or combination thereof.

In alternative embodiments of the composition or the products of manufacture of the invention, the seeds or the mixture of seeds are germinated or pretreated, or subjected to a pre-treatment, or the seeds or the mixture of seeds are mixed with a non-seed composition, optionally an active or inactive ingredient. The pre-treatment of the seeds or the mixture of seeds can comprise placing onto or administering to the seeds or the mixture of seeds a seed coating, and optionally the seed coating comprises an active ingredient.

In alternative embodiments of the composition or the products of manufacture of the invention, the seed coating comprises an absorbent polymer or a superabsorbent polymer, or the seeds or the mixture of seeds are mixed with an absorbent polymer or a superabsorbent polymer, and optionally the seed coating further comprises a binder or an adhesive compound or solution, or the seeds are mixed with a binder or an adhesive compound or solution.

In alternative embodiments of the composition or the products of manufacture of the invention, the active ingredient comprises a nutrient, a plant growth regulator, a plant hormone, an insecticide, a fungicide, a herbicide, a biological material, a singulating substance, or any combination thereof; and optionally the seeds or seed mixtures or the seed coating further comprise: a plant growth-enhancing active ingredient, e.g., a fertilizer, a pesticide, and the like; a soil-based nutrient, e.g., a solid, crystalline, aqueous, or liquid form nutrient; a pesticide; an acaricide; an algicide; an antifeedant; an avicide; a bactericide; a bird repellent; a chemosterilant; a fungicide; a herbicide safeners; an insect attractant or an insect repellent; a mammal repellent; a molluscicide; a nematicide; a plant activator; a plant growth regulator; a rodenticide; a synergist; a virucide, and any combination thereof.

In alternative embodiments of the composition or the products of manufacture of the invention, the absorbent polymer or the superabsorbent polymer comprises: a polyacrylamide; a polyacrylate; a starch; a starch graft copolymer; a starch-g-poly (2-propenamide-co-2-propenoic acid) potassium; or the absorbent polymer or the superabsorbent polymer, after coating the seed, or after mixing with the seeds or the mixture of seeds, is present in an amount of between about 0.01% and about 3.0%, between about 0.02% and about 2.0%, between about 0.05% and about 1.5%, between about 0.5% and about 1.0%, between about 0.05% and about 0.50%, of the weight of the seed.

In alternative embodiments of the composition or the products of manufacture of the invention, the singulating substance comprises: a talc, a calcium carbonate, a sodium sulfate, a mica, a magnesium sulfate, a wood flour, a silica, or any combination thereof; and optionally the singulating substance, after coating the seed, is present in an amount of between about 0.01% and about 3.0%, between about 0.02% and about 2.0%, between about 0.05% and about 1.5%, between about 0.5% and about 1.0%, between about 0.05% and about 0.50%, of the weight of the seed.

The invention provides methods for increasing Soil Organic Carbon (SOC) in a soil, comprising planting a seed, a composition or a product of manufacture of the invention, optionally for the purpose of measuring SOC sequestration for assessment under a UNCCC (United Nations Framework Convention on Climate Change) protocol.

In alternative embodiments of the methods of the invention, the C4 pathway grass or grasses are planted after the Atriplex planting, wherein optionally the C4 pathway grass or grasses are planted after the Atriplex planting any time within about the first year after the Atriplex planting, or after the first grazing of Atriplex, or in a 12 month period after the first grazing of Atriplex.

In alternative embodiments the methods further comprise preparing the soil to planted by: using a fertilizer or a mature organic fertilizer and/or a non-toxic inert liquid coloring agent to identify actual planting spots; and/or, applying a herbicide or fallowing; and optionally can further comprise preparing the soil to be planted by: initially applying a herbicide or fallowing, and/or applying a fertilizer and/or a mature organic slurry; and optionally applying a non-toxic inert liquid coloring agent to identify actual planting spots for precise water and slurry treatments after genus Atriplex seed planting.

In alternative embodiments of the methods of the invention, the mixture or the combination of seeds are planted sequentially to co-ordinate annual grazing; and optionally the mixture or the combination of seeds are planted to target a subsurface carbon (CO2e) sequestration objective of about 1 to 40 tonnes (metric tons) per hectare per annum, or 0.5 to 80 tonnes (metric tons) per hectare per annum.

In alternative embodiments of the methods of the invention, the mixture or combination when planted establishes between about 20 to 2000 genus Atriplex plants implanted in uniform rows per hectare with the C4 grasses lane planted in a density to provide full vegetation cover to the site. The planting sequence and/or plant choice can be determined according to the geographical, the seasonal rainfall and/or the soil factors of the locality for the planting.

In alternative embodiments of the methods of the invention, the mixture or the combination establishes between about 20 to 2000 genus Atriplex plants implanted in uniform rows per hectare with the C4 grasses lane planted in a density to provide full vegetation cover to the site.

In alternative embodiments of the methods of the invention, in higher rainfall areas the planted C4 grass is selected from a member of the group consisting of: a member of the family Fabaceae; a member of the family Leguminosae; a member of the genus Pennisetum; a Kikuyu grass; a Penniselum Clandestinum; a member of the genus Trifolium; a clover; a Trifolium alexandrinum, and a combination thereof.

The details of one or more embodiments of the invention are set forth in the description below. Other features, objects, and advantages of the invention will be apparent from the description and from the claims.

All publications, patents, patent applications cited herein are hereby expressly incorporated by reference for all purposes.

Reference will now be made in detail to various exemplary embodiments of the invention. The following detailed description is provided to give the reader a better understanding of certain details of aspects and embodiments of the invention, and should not be interpreted as a limitation on the scope of the invention.

### DETAILED DESCRIPTION

In alternative embodiments, the invention provides compositions and methods for the restoration of soil carbon content by carbon sequestration, or storage of carbon in a stable and sustainable form, for example, in an exhausted soil. In alternative embodiments, use of compositions of the invention, and by practicing methods of the invention, results in a net increase in Soil Organic Carbon (SOC). In alternative embodiments, compositions and methods of the invention increase SOC (e.g., restore soil carbon content by carbon sequestration in the soil) by using exemplary compositions of the invention, and in some embodiments, further use of plants and chemicals that will return into the soil carbon extracted from carbon dioxide in the air. In alternative embodiments, compositions of the invention include plants and also nutrients and associated soil bacteria which assimilate carbon dioxide and return it to the soil, e.g., including returning carbon dioxide to the soil that has been leached of carbon over the centuries through anthropogenic and natural activities. In alternative embodiments, compositions of the invention are used to sequester and store carbon in soils, e.g., in soils of dry lands, grass lands and range lands, and simultaneously sustain pastoral and agro-pastoral livelihoods for millions of people.

The invention provides methods comprising planting a combination or a mixture of C4 plants which have been identified in many studies as greater absorbers of atmospheric carbon than the vast majority of plants known to exhibit a C3 photosynthesis pathway, which are the vast majority of plants at 96%. In alternative embodiments, the invention provides methods comprising planting a combination or a mixture of C4 plants which have been found to be especially powerful in sequestering carbon into soil, which in one embodiment comprises at least two C4 photosynthesis pathway grasses and at least one of any member of the genus Atriplex (also called by the common names saltbush and orache) such as an Atriplex nummalaria. In alternative embodiments, methods of the invention comprise planting of combinations or mixtures serially and in varying combinations, and can further comprise planting of other plants, e.g., plants that can be added after initial planting to further increase sequestration, and/or to provide animal fodder or to grow marketable plants. In alternative embodiments, methods of the invention comprise planting of combinations or mixtures in areas where there are few or no plants, e.g., in desert soils, polluted soils, and in soils with increased salt content. In alternative embodiments, practicing methods and compositions of the invention provide for large scale re-vegetation which can permanently lower CO2e.

### Selection of Atriplex C4 Plants

In alternative embodiments, the invention provides compositions and methods comprising use of, e.g., as a plant or seed, at least one of any member of the genus Atriplex (also called by the common names saltbush and orache) at least one C4 photosynthesis pathway grass. Atriplex is a known C4 plant photosynthesis pathway plant, and is deep rooted, drought resistant and highly salt tolerant. Members of the genus Atriplex can sequester significant amounts of atmospheric carbon through its C4 pathway. Members of the genus Atriplex can store significant amounts of carbon in a deep and broad root system.

In alternative embodiments, the invention provides compositions and methods comprising combining (e.g., by mixing seeds, co-planting, or co-cultivation) at least one of any member of the genus Atriplex with at least one companion C4 grass. In alternative embodiments, methods of the invention comprise utilizing particular application processes to enhance growth and carbon storage.

In alternative embodiments, the invention provides compositions and methods comprising use of, e.g., as a plant or seed, at least one of any member of the genus Atriplex such as Atriplex nummalaria and other related species, all of which are significant sequesters of carbon in extensive root systems. In alternative embodiments, species of Atriplex which can be used to practice this invention include, for example, any one or combination of:
Atriplex canescens (Pursh) Nutt. Chamiso, Chamiza, Four-winged Saltbush, Grey Sagebrush: in North America
Atriplex centralasiatica Iljin: in Asia
Atriplex cinerea Poir. Grey Saltbush, Truganini: in Australia
Atriplex codonocarpa P. G. Wilson: in Australia
Atriplex conduplicata F. Muell.: in Australia
Atriplex confertifolia (Torr. & Frem.) S. Watson Shadscale (Saltbush): in North America
Atriplex cordobensis Gand. & Stuck.: in South America
Atriplex deserticola Phil.: in South America
Atriplex dimorphostegia Kar. & Kir.: in North Africa
Atriplex eardleyae Aellen: in Australia
Atriplex elachophvlla F. Muell.: in Australia
Atriplex fissivalvis F. Muell.: in Australia
Atriplex flabellum Bunge ex Boiss.: in Eurasia
Atriplex gardneri (Moq.) D. Dietr. Gardner's saltbush, Moundscale: in NorthAmerica
Atriplex glauca L.: in Portugal, Spain and in North Africa
Atriplex halimus L. Mediterranean Saltbush, Sea Orache, Shrubby Orache: in South Europe, North Africa and Southwest Asia
Atriplex herzogii Standl.: in North America
Atriplex holocarpa F. Muell.: in Australia
Atriplex hymenelytra (Ton.) S. Watson Desert Holly: in North America
Atriplex hymenotheca Moq.: in Australia
Atriplex imbricata (Moq.) D. Dietr.: in South America
Atriplex inamoena Aellen: in Eurasia
Atriplex intermedia Anderson: in Australia
Atriplex isatidea Moq.: in Australia
Atriplex laciniata L. Frosted Orache: In West and North Europe
Atriplex lampa (Moq.) Gillies ex Small: in South America
Atriplex lehmanniana Bunge: in Eurasia
Atriplex lentiformis (Ton.) S. Watson Quail Bush: in North America
Atriplex leptocarpa F. Muell.: in Australia
Atriplex leucoclada. Boiss.: in Eurasia
Atriplex leucophylla (Moq.) D. Dietr.: in North America
Atriplex lindleyi Moq.: in Australia
Atriplex moneta Bunge ex Boiss.: in Eurasia
Atriplex muelleri Benth.: in Australia
Atriplex nessorhina. S. W. L. Jacobs: in Australia
Atriplex obovata Moq.: in North America
Atriplex pamirica Iljin: in Eurasia
Atriplex parishii S. Watson: in North America
Atriplex parryi S. Watson: in North America
Atriplex parvifolia Kunth: in South America
Atriplex patagonica (Moq.) D. Dietr.: in South America
Atriplex phyllostegia (Torn ex S. Watson) S. Watson: in North America
Atriplex polycarpa (Torn) S. Watson—Allscale (Saltbush), Desert Saltbush, Cattle Saltbush, Cattle Spinach: in North America
Atriplex powellii S. Watson—Powell's Saltbush: in North America
Atriplex pseudocampanulata Aellen: in Australia
Atriplex quinii F. Muell.: in Australia
Atriplex recurva d′Urv.: in Eurasia, endemic to the Aegaeis
Atriplex rhagodioides F. Muell.: in Australia
Atriplex rosea L.—Tumbling Orache: in Eurasia and North Africa
Atriplex rusbyi Britton ex Rusby: in South America
Atriplex schugnanica Iljin: in Asia
Atriplex semibaccata R. Br.—Australian Saltbush, Berry Saltbush, Creeping Saltbush: in Australia
Atriplex semilunaris Aellen: in Australia
Atriplex serenana A. Nelson ex Abrams: in North America
Atriplex sibirica L.; in Asia, naturalized in Europe
Atriplex sphaeromorpha Iljin: in Russia, Ukraine and Caucasus
Atriplex spinibractea Anderson: in Australia
Atriplex spongiosa F. Muell.: in Australia
Atriplex stipitata Benth.: in Australia
Atriplex sturtii S. W. L. Jacobs: in Australia
Atriplex suberecta I. Verd.—sprawling saltbush, lagoon saltbush: in Australia
Atriplex tatarica Aellen: in Europe, North Africa and Asia
Atriplex turbinata (Anderson) Aellen: in Australia
Atriplex undulata (Moq.) D. Dietr.: in South America
Atriplex velutinella F. Muell.: in Australia
Atriplex vesicaria Heward ex Benth.—Bladder Saltbush: in Australia

### Selection of C4 Grasses

In alternative embodiments, the invention provides compositions and methods comprising use of, e.g., as a plant or seed, at least one C4 photosynthesis pathway grass, and at least one of any member of the genus Atriplex; or in alternative embodiments, at least two C4 photosynthesis pathway grasses, and at least one of any member of the genus Atriplex. In alternative embodiments the companion C4 grasses enhance the carbon sequestration outcomes of a planting site, prevent water and wind caused erosion, provide valuable fodder for grazing, assist in the build-up of vital organic matter and encourage the growth of soil microbes.

In alternative embodiments, the invention provides methods of planting and cultivation, wherein the “companion” C4 pathway grasses are planted after the Atriplex planting, e.g., any time within about the first year after the Atriplex planting, or after the first grazing of Atriplex, or in a 12 month period after the first grazing of Atriplex.

Any one or combination of companion grasses used to practice this invention can vary, e.g., according to the site characteristics such as soil, rainfall, geography, and the like. Seed availability also can be a factor. In alternative embodiments, the at least one, or the at least two, C4 photosynthesis pathway grass or grasses, which can be used to practice this invention include, for example, any one or combination of: In dry zones, any one or combination of (for example, two to three of) the following C4 grasses can be used:

| GENERA | COMMON NAME |
|---|---|
| Aristida | Wire Grass |
| Astrebla | Mitchell grass |
| Bothriochloa | Blue & Red-leg grass |
| Brachiaria | Armgrass |
| Brachyachne (ciliaris) | Hairy native couch |
| Chloris | Windmill-grass |
| Chrysopogon (fallax) | Golden-beard grass |
| Cymbopogon | Lemon-scented grass & Silky-heads |
| Cynodon (dactylon var. pulchellus) | Couch-grass |
| Dactyloctenium (radulans) | Button grass |
| Dichanthium | Blue-grass |
| Digitaria | Spider grass |
| Distichlis (distichophylla) | Emu or Salt-grass |
| Echinochloa | Channel millet |
| Enneapogon | Bottle-washers |
| Enteropogon | Umbrella-grass & Curly windmill- |
| | grass |
| Eragrostis | Lovegrass |
| Eriachne | Wanderrie |
| Eriochloa | Cupgrass |
| Eulalia (aurea) | Sugar-grass |
| Hemarthria (uncinata) | Mat grass |
| Imperata (cylindrica) | Kunai grass |
| Iseilema | Flinders-grass |
| Leptochloa | Umbrella cane-grass & Beetle-grass |
| Neurachne (munroi) | Window mulga-grass |
| Oxychloris (scariosa) | Winged chloris |
| Panicum | Panic & Native millet |
| Paractaenum | Barbed-wire grass |
| Paraneurachne (muelleri) | Northern mulga-grass |
| Perotis (rara) | Comet grass |
| Pseudoraphis (spinescens) | Spiny mud-grass |
| Setaria | Pigeon-grass & Paspalidium |
| Spinifex (hirsutus) | Rolling spinifex |
| Sporobolus | Dropseed |
| Themeda | Kangaroo grass |
| Tragus (australianus) | Burr-grass |
| Triodia | Spinifex & Porcupine grass |
| Tripogon (loliiformis) | Five-minute grass |
| Triraphis (mollis) | Purple heads |
| Uranthoecium (truncatum) | Flat-stem grass |
| Yakirra (australiensis) | Bunch panic |
| Zoysia (macrantha) | Manila grass |
| Zygochloa (paradoxa) | Sandhill cane-grass |

Any C4 grass can be used, see, e.g., “Understanding C3 and C4 Native Grass Species”, Native Grass Resources Group Inc. Other fodder productive C4 grasses can be used to practice this invention, and each can be evaluated for inclusion in the carbon sequester combination where appropriate.

In higher rainfall areas, any C4 grass member of the family Fabaceae or Leguminosae can be used, for example, any member of the genus Pennisetum (e.g., Kikuyu grass, or Penniselum Clandestinum) can be used, or any member of the genus Trifolium, i.e., any clover (e.g. Trifolium alexandrinum) can be used.

In alternative embodiments, the C4 photosynthesis pathway grasses and genus Atriplex carbon sequester combination of the invention can increase the estimated soil carbon baseline in semi-arid lands and grasslands, e.g., across Australian semi-arid lands and grasslands. Recent studies in these areas have calculated an estimated 5 tonnes (metric tons) carbon per hectare above ground and 25 tonnes (metric tons) carbon approximately a meter underground, and practicing the methods of the invention can increase the volume of carbon storage significantly, e.g., the planting of Atriplex alone will add an estimated 40 tonnes per hectare per year to a soil carbon profile.

### Carbon Baseline

In alternative embodiments, use of compositions of the invention, and by practicing methods of the invention, results in a net increase in Soil Organic Carbon (SOC). In alternative embodiments, compositions and methods of the invention increase SOC (e.g., restore soil carbon content by carbon sequestration in the soil) by using exemplary compositions of the invention, and in some embodiments, further use of plants and chemicals that will return into the soil carbon extracted from carbon dioxide in the air.

In alternative embodiments, methods of the invention commence with measuring the baseline levels of carbon and various elements in the soil by core sampling of the selected site. This testing can comply with UNCCC (United Nations Framework Convention on Climate Change) protocols to establish the carbon baseline of the site.

In alternative embodiments the international standard to identify soil carbon levels will be used. In alternative embodiments, protocols as identified by the Australian Government Soil Carbon Research Program are used; for example, they have published a number of methods for identifying soil carbon levels including a mid-infrared spectrometer (MIR), including the Hydrolytic Reaction calculations, the Soil Survey Standard Test Method for Organic Carbon as issued by the Department of Sustainable Natural Resources, and the standard tests for the determination of soil dehydrogenase activity (DHA). In alternative embodiments, methods recommended by Mr Peter Donovan (October 2013) described in “A flexible, practical, local method” will also be applied to the site, that is the usage of the “dry combination method” also known as “elemental analysis” (Donovan, 12), are used. Laboratory acid tests can distinguish between organic and inorganic carbon. UNCCC sanctioned best practice methods can be used in the calculation of the baseline. Upon the determination of the “carbon” levels in the site to be planted, the result is registered as the “baseline carbon”.

In alternative embodiments, methods of the invention comprise measuring levels of salts (e.g., sodium); aluminium; heavy metals such as lead (Pb), chromium (Cr), arsenic (As), zinc (Zn), cadmium (Cd), copper (Cu), mercury (Hg), and nickel (Ni); and/or other pollutants and contaminants, e.g., petroleum hydrocarbons, polynuclear aromatic hydrocarbons (such as naphthalene and benzo(a)pyrene), solvents, pesticides, in sand or existing soil.

### Site Preparation

In alternative embodiments, methods of the invention comprise increasing Soil Organic Carbon (SOC) in a soil, comprising planting a combination of seeds of a composition of the invention or a product of manufacture of the invention. In alternative embodiments, methods of the invention comprise preparing a planting site; for example, a site can be cleared or planted clear of any competing weeds or grass. This may require the application of a knockdown herbicide, and/or fallowing at least six months prior to planting. Appropriate fencing can be constructed to prevent stray animals entering the site. Solar powered electric fencing can be an effective deterrent.

In alternative embodiments, methods of the invention comprise “deep ripping”, which where practical can be of assistance to promote carbon uptake (“Productivity of old man saltbush in relation to rainfall and economic considerations”, Australian Society of Agronomy, R. W. Condon and A. L. Sippell).

In alternative embodiments, prior to planting a decision has to be made as to whether grazing will be carried out on the planted land or whether this will be for planting other crops.

In alternative embodiments, methods of the invention comprise rainfall modeling and tests to determine the soil profile will assist in the determination of the combination of grasses to be planted with Atriplex. Biodiversity studies can be conducted to determine the need (if any) for offsets.

Fertilizers

In alternative embodiments, methods of the invention comprise preparing a site for planting by using a mature organic “fertilizer” and a non-toxic inert liquid colouring agent to identify the actual seed planting spots. For example, a coloured fertilizer liquid can to be sprayed in a 10 cm clear area for each of the seeds of Atriplex, e.g., Atriplex nummalaria.

Where appropriate, an anaerobic digester to break down manure and vegetation into a slurry will be utilised. Animal manure coupled with rotting vegetation (grass, vegetation pruning, and vegetable food scraps) can be combined in an anaerobic digester. Animal manure also can be incorporated, although it always contains a fraction of volatile organic components, viz. volatile fatty acids (VFA). Where the usage of an organic slurry is not practical an effective commercial fertilizer can be substituted.

### Seed and Seed Mixture Preparation

Prior to planting of grass or Atriplex, e.g., A. nummalaria, seed, the seeds or the mixture of seeds, can be pretreated with, coated with, and/or mixed with another substance, e.g., an active or an inactive ingredient, e.g., an absorbent polymer or a superabsorbent polymer (e.g., as a seed coating), a nutrient, a plant growth regulator, a plant hormone, an insecticide, a fungicide, a herbicide, a biological material, a singulating substance, or any combination thereof. For example, seed can be placed in an incubator. The incubation assists in germination (cracking is initially set at 20±1° C. This has a significant effect upon seed germination. Other agents that are used in preparing for germination include potassium nitrate (0.2% concentration), gibberellic acid (100 and 150 ppm) and sulfuric acid (25% for 10 min, 50% for 10 and 20 min). In alternative embodiments seed germination is improved when compared to planting without such pre-germination treatment.

In alternative embodiments after pre-germination, the seeds or mixture of seeds are centrifuged or shaken using a container, e.g., an aluminium bag, in the absence of a centrifuge unit. Drying seeds enables single seed to drop more easily from the planter otherwise they might stick if not completely dry.

In alternative embodiments, the seeds or seed mixtures of the invention are mixed with a singulating substance, or the seed coating comprises a singulating substance, which may be mixed into the absorbent polymer or the superabsorbent polymer seed treatment. In alternative embodiments, the singulating substance alleviates seed clumping, and facilitates treated seeds to separate from each other. In alternative embodiments singulating substance comprise any substance that assists the seeds in separating one from another, e.g., while the seeds are substantially wet. In alternative embodiments singulating substances comprise a talc or any dry solid or powders, e.g., calcium carbonate, sodium sulfate, mica, magnesium sulfate, wood flour, and silica, or mixture thereof.

In alternative embodiments, the absorbent polymer or superabsorbent polymer comprises a starch, a starch graft copolymer, a starch-g-poly (2-propenamide-co-2-propenoic acid) potassium salt starch graft copolymer, e.g., ZEBA™ (Absorbent Technologies, Inc).

In alternative embodiments, the seeds or seed mixtures of the invention further comprise a biological material, e.g., a bacteria or a fungi, e.g., a bacteria of the genera Rhizobium, Pseudomonas, Azospirillum, and/or Serratia; fungi of the genera Trichoderma, Glomus, Beauveria, Gliocladium, and/or Penicillium; and/or a mycorrhizal fungi, which optionally are part of a seed coating.

In alternative embodiments, the seeds or seed mixtures of the invention, or the seed coatings, further comprise: a plant growth-enhancing active ingredient, e.g., a fertilizer, a pesticide, and the like; a soil-based nutrient, e.g., a solid, crystalline, aqueous, or liquid form nutrient; a pesticide; an acaricide; an algicide; an antifeedant; an avicide; a bactericide; a bird repellent; a chemosterilant; a fungicide; a herbicide safeners; an insect attractant or an insect repellent; a mammal repellent; a molluscicide; a nematicide; a plant activator; a plant growth regulator; a rodenticide; a synergist; a virucide, and any combination thereof.

In alternative embodiments, the seeds or seed mixtures of the invention, or the seed coatings, further comprise: an insecticide or an insecticide-type active ingredient, e.g., thiodan, diazinon, malathion, imidacloprid, clothianidin, thiamethoxam, thiodicarb, beta-cyfluthrin, and abamectin, clothianidin, beta-cyfluthrin, thiodicarb, imidacloprid, or any combination thereof.

In alternative embodiments, the seeds or seed mixtures of the invention, or the seed coatings, further comprise: a fungicide, e.g., captan, thiram, metalaxyl, ipconazole, triticonazole, prothioconazole, flutolanil, myclobutanil, triadimenol, pyraclostrobin, boscalid, aluminum tris (o-ethylphosphenate), iprodione, kresoxim-methyl, trifloxystrobin, mefenoxam, methoxyacetylamino-(R)-2-2[2,6-dimethylphenyl-propionic acid methyl ester], difenoconazole, chlorothalonil, carboxin, fludioxonil, azoxystrobin, tebuconazole, prothioconazole, tebuconazole, metalaxyl, trifloxystrobin, triadimenol, metalaxyl, carboxin, thiram, boscalid, pyraclostrobin, difenoconazole, mefenoxam, or any combination thereof.

In alternative embodiments, the seeds or seed mixtures of the invention, or the seed coatings, further comprise: a nutrient or a soil-based nutrient, or calcium, magnesium, potassium, phosphorus, boron, zinc, manganese, copper, iron, sulfur, nitrogen, molybdenum, fish meal, or any combination or blend thereof.

In alternative embodiments, absorbent polymers include polyacrylamides and polyacrylates, or synthetic superabsorbent polymers, e.g., as described e.g., in U.S Pat. App. Pub. No. 20120277099; or those made by graft polymerizing a monomer onto a starch in the presence of an initiator to form a starch graft copolymer, cross-linking the starch graft copolymer, adjusting the pH of the cross-linked starch graft copolymer such as by neutralization, and isolating and drying the cross-linked starch graft copolymer.

In alternative embodiments exemplary monomers or ingredients for use in absorbent polymers or superabsorbent polymers comprise acrylonitrile, acrylic acid, methacrylic acid, acrylamide, methacrylamide, sulfonic acids, 2-acrylamido-2-methyl-propanesulfonic acid (AMPS), vinyl sulfonic acid, acrylates, ethyl acrylate potassium acrylate, and combinations thereof.

In alternative embodiments, exemplary methods of forming absorbent polymers, including superabsorbent polymers, e.g., starch graft copolymer superabsorbent polymers, include those described in e.g., U.S. Pat. Nos. 6,800,712; 7,423,090, and in U.S Pat. App. Pub. No. 20120277099.

### Planting Atriplex

In alternative embodiments, for the purpose of planting, a seeding machine is used to drop the seed into the ground, e.g., specifically where the colored fertilizer indicators were placed. In alternative embodiments, seeds are then covered by about 2 to 3 mm of soil or sand, e.g., to secure the seeds from birds or wind. In alternative embodiments, just prior to the seed dropping into the space for its planting, a jet of water is directed at the fertilizer zone to give the seed early water supply.

The planting numbers are relevant to the soil application either for grazing or for planting crops. The prime application in a desert area would be for grazing. There may be some variation in terms of density of planting when applied to crop planting zones. In alternative embodiments an objective is around 2000 plants per hectare. For sheep, the planting can be in rows 4.5 meters (m) apart; this would allow placing the manure and/or fertilizer into center rows. Following the planting of seeds another and more precise spray of water can be injected over the seed zone.

In alternative embodiments, when planting the objective is to provide fodder for grazing as well as maximising carbon sequestration, planting is set out in rows for grazing management purposes. Rows can be set out with each row set back to allow livestock to graze along the rows. Three (3) days following planting, an additional water spray over the coloured zone can be carried out subject to soil quality and can be repeated for a total of 3 times separated by 3 days at a time.

Sprouting of seeds can take place ranging from one week to four weeks. Depending on rainfall and various weather conditions the rows can then be grazed in the future. The mean cycle of growth is once per year. Mature plants can average 1.86 m with a large foliage area. This plant growth can support an increase of 5 to 7 times the production level above the historical rate of grassland production.

In alternative embodiments, livestock is introduced on average 12 months after planting for light grazing. This access to the consumption of leaf cover can increase annually to 2 to 3 years whereupon the plant is matured; a 5 to 10% of leaf cover following grazing may remain. This is an average optimal leftover cover of sheep moving through this row cultivation. An access water trough at the end of every second row may be required to meet the requirements of grazing livestock.

### Planting of Companion Grasses

In alternative embodiments, methods of the invention comprise planting at least two C4 photosynthesis pathway grasses with at least one of any member of the genus Atriplex; or, comprise planting at least one C4 photosynthesis pathway grass with at least one of any member of the genus Atriplex. In alternative embodiments, in selecting C4 photosynthesis pathway grasses to be used, the nutritional qualities for livestock of each companion grass is assessed in conjunction with the appropriate species of Atriplex to balance animal dietary needs, palatability and seasonal plant growth factors.

In alternative embodiments, methods of the invention comprise setting or planting plants in rows about 20 cm apart. Site preparation for C4 photosynthesis pathway grasses can be similar to Atriplex implantation, as described above, including fertilizer and water application. The seeds can be applied by a centrifugal spreader. The application can be approximately 10 kg/hectare of grass seed. Mature grasses may be needed in year 3 as a part of the combination grazing/sequestration system described here. The livestock can be grazed in separate blocks or rows allowing companion grasses to grow and spread. The advantage of the above rotational grazing protocol allows for a consistent high meat yield in the case of sheep, goats and lama-like animals.

Depending on the site objective there may be need for increased planting density per hectare. This of course will translate to an increase in carbon. Following the consolidation of the array of vegetation (a combination of the invention) planted it is then possible to support, for example, forestry development. There may be a demand for further pre-planting assessment including, e.g., soil carbon levels, and the planting can be replicated, e.g., at years 3, 6 and 10.

### Carbon Sequestration Assessment

Soil tests to be conducted as above after year 3, 6 and 10 and then every few years to determine the accumulation of carbon in the soil. This data could provide the basis for carbon trading under UN protocols.

A number of embodiments of the invention have been described. Nevertheless, it will be understood that various modifications may be made without departing from the spirit and scope of the invention. Accordingly, other embodiments are within the scope of the following claims.

1. A composition comprising, or consisting of, a mixture or a combination of seeds, wherein the mixture or combination comprises seeds of at least one C4 photosynthesis pathway grass and at least one of any member of the genus Atriplex,
wherein optionally the mixture or combination is about 50% C4 photosynthesis pathway grass and 50%) genus Atriplex, or between about 1% to 99% C4 photosynthesis pathway grass to a corresponding 1% to 99% genus Atriplex,
and optionally the mixture or combination comprises seeds of at least two different C4 photosynthesis pathway grasses and at least one of any member of the genus Atriplex.

2. A product of manufacture comprising, or consisting of, a mixture or a
combination of seeds, wherein the mixture or combination comprises seeds of at least one C4 photosynthesis pathway grass and at least one of any member of the genus Atriplex,
wherein optionally the mixture is about 50% o C4 photosynthesis pathway grass and 50% genus Atriplex, or between about 1% to 99% C4 photosynthesis pathway grass to a
corresponding 1% to 99% genus Atriplex,
and optionally the mixture or combination comprises seeds of at least two different C4 photosynthesis pathway grasses and at least one of any member of the genus Atriplex.

3. The composition of claim 1, wherein the at least one of any member of the genus
Atriplex is selected from the group consisting of,
Atriplex canesce s (Pursh) Nutt.—Chamiso, Chamiza, Four-winged Saltbush, Grey Sagebrush, in North America,
Atriplex centralasiatica Iljin, in Asia,
Atriplex cinerea Poir, Grey Saltbush, Truganini, in Australia,
Atriplex codonocarpa P. G. Wilson, in Australia,
Atriplex conduplicata F. uell, in Australia,
Atriplex confertifolia (Torr. & Frem.) S. Watson, Shadscale (Saltbush), in North America,
Atriplex cordobensis Gand. & Stuck, in South America,
Atriplex deserticola Phil, in South America,
Atriplex dimorphostegia ar. & Kir, in North Africa,
Atriplex eardleyae Aellen, in Australia,
Atriplex elachophvlla F. Muell, in Australia,
Atriplex fissivalvis F. Muell, in Australia,
Atriplex flabellum Bunge ex Boiss, in Eurasia,
Atriplex gardneri (Moq.) D. Dietr, Gardner's saltbush, Moundscale, in NorthAmerica,
Atriplex glauca L, in Portugal, Spain and in North Africa,
Atriplex halimus L, Mediterranean Saltbush, Sea Orache, Shrubby Orache, South, Europe, North Africa and Southwest Asia,
Atriplex herzogii Standi, in North America,
Atriplex holocarpa F. Muell, in Australia,
Atriplex hymenelytra (Ton.) S. Watson, Desert Holly, in North America,
Atriplex hymenotheca Moq, in Australia,
Atriplex imbricate (Moq.) D. Dietr, in South America,
Atriplex inamoena Aellen, in Eurasia,
Atriplex intermedia Anderson, in Australia,
Atriplex isatidea Moq, in Australia,
Atriplex laciniata L., Frosted Orache, In West and North Europe,
Atriplex lampa (Moq.) Gillies ex Small, in South America,
Atriplex lehmanniana Bunge, in Eurasia,
Atriplex lentiformis (Ton.) S. Watson, Quail Bush, in North America,
Atriplex leptocarpa F. Muell, in Australia,
Atriplex leucoclada Boiss, in Eurasia,
Atriplex leucophylla (Moq.) D. Dietr, in North America,
Atriplex lindleyi Moq, in Australia,
Atriplex moneta Bunge ex Boiss, in Eurasia,
Atriplex muelleri Benth, in Australia,
Atriplex nessorhina S. W. L. Jacobs, in Australia,
Atriplex obovata Moq, in North America,
Atriplex pamirica Iljin, in Eurasia,
Atriplex parishii S. Watson, in North America,
Atriplex parryi S. Watson, in North America,
Atriplex parvifolia Kunth, in South America,
Atriplex patagonica (Moq.) D. Dietr, in South America,
Atriplex phyllostegia (Torn ex S. Watson) S. Watson, in North America,
Atriplex polycarpa (Torr.) S. Watson—Allscale (Saltbush), Desert Saltbush, Cattle Saltbush, Cattle Spinach, in North America,
Atriplex powellii S. Watson—Powell's Saltbush, in North America,
Atriplex pseudocampanulata Aellen, in Australia
Atriplex quinii F. Muell, in Australia
Atriplex recurva d′Urv, in Eurasia, endemic to the Aegaeis
Atriplex rhagodioides F. Muell, in Australia
Atriplex rosea L.—Tumbling Orache, in Eurasia and North Africa
Atriplex rusbyi Britton ex Rusby, in South America
Atriplex schugnanica Iljin, in Asia
Atriplex semibaccata R. Br., Australian Saltbush, Berry Saltbush, Creeping Saltbush, in Australia,
Atriplex semilunaris Aellen, in Australia,
Atriplex serenana A. Nelson ex Abrams, in North America,
Atriplex sibirica L.; in Asia, naturalized in Europe,
Atriplex sphaeromorpha Iljin, in Russia, Ukraine and Caucasus,
Atriplex spinibractea Anderson, in Australia,
Atriplex spongiosa F. Muell, in Australia,
Atriplex stipitata Benth, in Australia,
Atriplex sturtii S. W. L. Jacobs, in Australia,
Atriplex suberecta I. Verd.—sprawling saltbush, lagoon saltbush, in Australia,
Atriplex tatarica Aellen, in Europe, North Africa and Asia,
Atriplex turbinata (Anderson) Aellen, in Australia,
Atriplex undulata (Moq.) D. Dietr, in South America,
Atriplex velutinella F. Muell, in Australia,
Atriplex vesicaria Heward ex Benth.—Bladder Saltbush, in Australia, and any mixture or combination thereof.

4. The composition of claim 1, wherein the i C4 pathway grass is selected from the group consisting of:
Aristida Wire Grass,
Astrebla Mitchell grass,
Bothriochloa Blue & Red-leg grass,
Brachiaria Armgrass,
Brachyachne (ciliaris) Hairy native couch,
Chloris Windmill-grass,
Chrysopogon (fallax) Golden-beard grass,
Cymbopogon Lemon-scented grass & Silky-heads,
Cynodon (dactylon var. pulchellus) Couch-grass,
Dactyloctenium (radulans) Button grass,
Dichanthium Blue-grass,
Digitaria Spider grass,
Distichlis (distichophylla) Emu or Salt-grass,
Echinochloa Channel millet,
Enneapogon Bottle-washers,
Enteropogon Umbrella-grass & Curly windmill-grass,
Eragrostis Lovegrass,
Eriachne Wanderrie,
Eriochloa Cupgrass,
Eulalia (aurea) Sugar-grass,
Hemarthria (uncinata) Mat grass,
Iraperata (cylindrica) Kunai grass,
Iseilema Flinders-grass,
Leptochloa Umbrella cane-grass & Beetle-grass,
Neurachne (raunroi) Window mulga-grass,
Oxychloris (scariosa) Winged chloris,
Panic urn Panic & Native millet,
Paractaenum Barbed-wire grass,
Paraneurachne (muelleri) Northern mulga-grass,
Perotis (rara) Comet grass,
Pseudoraphis (spinescens) Spiny mud-grass,
Setaria Pigeon-grass & Paspalidium,
Spinifex (hirsutus) Rolling spinifex,
Sporobolus Dropseed,
Themeda Kangaroo grass,
Tragus (australianus) Burr-grass,
Triodia Spinifex & Porcupine grass,
Tripogon (loliiform is) Five-minute grass,
Triraphis (mollis) Purple heads,
Uranthoecium (truncatum) Flat-stem grass,
Yakirra (australiensis) Bunch panic,
Zoysia (macrantha) Manila grass,
Zygochloa (paradoxa) Sandhill cane-grass,
any C4 grass member of the family Fabaceae or Leguminosae,
any member of the genus Petmiseium;
a Kikuyu grass, or Penniselum Clandestinum,
any member of the genus Trifolium, or any clover,
a Trifolium alexandrinum, and
any mixture or combination thereof.

5. The composition of claim 1, wherein the seeds or the mixture of seeds are germinated or pretreated, or subjected to a pretreatment, or the seeds or the mixture of seeds are mixed with a non-seed composition, optionally an active or inactive ingredient.

6. The composition of claim 5, wherein the pretreatment of the seeds or the mixture of seeds comprises placing onto or administering to the seeds or the mixture of seeds a seed coating, and optionally the seed coating comprises an active ingredient.

7. The composition of claim 6, wherein the seed coating comprises an absorbent polymer or a superabsorbent polymer, or the seeds or the mixture of seeds are mixed with an absorbent polymer or a superabsorbent polymer, and optionally the seed coating further comprises a binder or an adhesive compound or solution, or the seeds are mixed with a binder or an adhesive compound or solution.

8. The composition of claim 5, wherein the active ingredient comprises a nutrient, a plant growth regulator, a plant hormone, an insecticide, a fungicide, a herbicide, a biological material, a singulating substance, or any combination thereof,
and optionally the seeds or seed mixtures or the seed coating further comprise: a plant growth-enhancing active ingredient, e.g., a fertilizer, a pesticide, and the like; a soil-based nutrient, e.g., a solid, crystalline, aqueous, or liquid form nutrient; a pesticide; an acaricide; an algicide; an antifeedant; an avicide; a bactericide; a bird repellent; a chemosterilant; a fungicide; a herbicide safeners; an insect attractant or an insect repellent; a mammal repellent; a molluscicide; a nematicide; a plant activator; a plant growth regulator; a rodenticide; a synergist; a virucide, and any combination thereof.

9. The composition of claim 7, wherein the absorbent polymer or the superabsorbent polymer comprises: a polyacrylamide; a polyacrylate; a starch; a starch graft copolymer; a starch-g-poly (2-propenamide-co-2-propenoic acid) potassium.

10. The composition of claim 7, wherein the absorbent polymer or the superabsorbent polymer, after coating the seed, or after mixing with the seeds or the mixture of seeds, is present in an amount of between about 0.01% and about 3.0%, between about 0.02% and about 2.0%, between about 0.05% and about 1.5%, between about 0.5% and about 1.0%, between about 0.05% and about 0.50%, of the weight of the seed.

11. The composition of claim 8, wherein the singulating substance comprises: a talc, a calcium carbonate, a sodium sulfate, a mica, a magnesium sulfate, a wood flour, a silica, or any combination thereof.

12. The composition of claim 8, wherein the singulating substance, after coating the seed, is present in an amount of between about 0.01% and about 3.0%, between about 0.02% and about 2.0%, between about 0.05% and about 1.5%, between about 0.5% and about 1.0%, between about 0.05%) and about 0.50%, of the weight of the seed.

13. A method for increasing Soil Organic Carbon (SOC) in a soil, comprising planting, a composition or a seed of claim 1, optionally for the purpose of measuring SOC sequestration for assessment under a UNCCC (United Nations Framework Convention on Climate Change) protocol.

14. The method of claim 13, wherein the C4 pathway grass or grasses are planted after the Atriplex planting,
wherein optionally the C4 pathway grass or grasses are planted after the Atriplex planting any time within about the first year after the Atriplex planting, or after the first grazing of Atriplex, or in a 12 month period after the first grazing of Atriplex.

15. The method of claim 13, further comprising preparing the soil to planted by: using a fertilizer or a mature organic fertilizer and/or a non-toxic inert liquid coloring agent to identify actual planting spots; and/or, applying a herbicide or fallowing.

16. The method claim 13 to 15, further comprising preparing the soil to be planted by: initially applying a herbicide or fallowing, and/or applying a fertilizer and/or a mature organic slurry; and optionally applying a non-toxic inert liquid coloring agent to identify actual planting spots for precise water and slurry treatments after genus Atriplex seed planting.

17. The method of claim 13 to 16, wherein the mixture or the combination of seeds are planted sequentially to co-ordinate annual grazing.

18. The method claim 13 to 17, wherein the mixture or the combination of seeds are planted to target a subsurface carbon (C02e) sequestration objective of about 1 to 40 tonnes (metric tons) per hectare per annum, or 0.5 to 80 tonnes (metric tons) per hectare per annum.

19. The method of any of claim 13, wherein the mixture or combination when planted establishes between about 20 to 2000 genus Atriplex plants implanted in uniform rows per hectare with the C4 grasses lane planted in a density to provide full vegetation cover to the site.

20. The method claim 13, wherein:
(a) the planting sequence and plant choice is determined according to the geographical, the seasonal rainfall and/or the soil factors of the locality for the planting;
(b) the mixture or the combination establishes between about 20 to 2000 genus Atriplex plants implanted in uniform rows per hectare with the C4 grasses lane planted in a density to provide full vegetation cover to the site; or
(c) in higher rainfall areas the planted C4 grass is selected from a member of the group consisting of: a member of the family Fabaceae; a member of the family Leguminosae; a member of the genus Petmisetiun; a Kikuyu grass; a Penniselum Clandestinum; a member of the genus Trifolium; a clover; a Trifolium alexandrinum, and a combination thereof.

21-22. (canceled)
